(19) United States
(12) Patent Application Publication
(10) Pub. No.: US 2016/0218480 A1
(43) Pub. Date: Jul. 28, 2016

(54) LASER APPARATUS

(71) Applicant: HAMAMATSU PHOTONICS K.K., Shizuoka (JP)

(72) Inventors: Hiroshi SAKAI, Hamamatsu-shi (JP); Hirotake FUKUOKA, Hamamatsu-shi (JP); Noriyasu SUZUKI, Hamamatsu-shi (JP)

(21) Appl. No.: 15/024,417

(22) PCT Filed: Sep. 22, 2014
(86) PCT No.: PCT/JP2014/075120

§ 371 Date: Mar. 24, 2016

(30) Foreign Application Priority Data
Sep. 30, 2013 (JP) 2013-203675

(51) Int. Cl. H01S 3/094; H01S 3/16; H01S 3/0941

(52) U.S. Cl. CPC H01S 3/094053; H01S 3/0941; H01S 3/1611; H01S 3/1643; H01S 3/1673

(57) ABSTRACT

A laser apparatus includes a semiconductor laser being a light source that emits light, an optical fiber that inputs the light emitted from the semiconductor laser and guides and outputs the light, and an optical resonator that has a laser medium into which the light output from the optical fiber is input and emits laser light. The optical fiber has a GI fiber constituting a part on a light input side and an SI fiber connected to the GI fiber and constituting a part on a light output side.

### TECHNICAL FIELD

The present invention relates to a laser apparatus.

### BACKGROUND ART

There has been known a conventional laser apparatus provided with a light source that emits light, an optical fiber that guides and outputs the light emitted from the light source, and a laser oscillator that causes the light output from the optical fiber to enter a laser medium and emits laser light (see, for example, Patent Literatures 1 and 2 and Non-Patent Literatures 1 and 2).

### CITATION LIST

### Patent Literature

Patent Literature 1: Japanese Patent Application Laid-Open Publication No. H7-106665

Patent Literature 2: Japanese Patent Application Laid-Open Publication No. 2011-127529

### Non Patent Literature

Non-Patent Literature 1: A. Agnesi, E. Piccinini, G. C. Reali, and C. Solcia, “Efficient all-solid-state tunable source based on a passively Q-switched high-power Nd:YAG laser”, Appl. Phys. B 65, pp. 303-305 (1997)

Non-Patent Literature 2: H. Sakai, H. Kan, and T. Taira, “>1 MW peak power single-mode high-brightness passively Q-switched Nd3+:YAG microchip laser”, Opt. Express Vol. 16 No. 24, pp. 19891-19899 (2008)

### SUMMARY OF INVENTION

### Technical Problem

Here, in the above-described laser apparatus, in some cases, output of the laser light becomes unstable, or the output of the laser light is decreased.

Accordingly, an object of the present invention is to provide a laser apparatus with which it is possible to obtain laser light with stable and sufficient output.

### Solution to Problem

As a result of extensive examinations to achieve the above-described object, the present inventors have found out that a phenomenon in which the output of the laser light becomes unstable or the output of the laser light is decreased seen in the conventional laser apparatus is caused by a characteristic of the optical fiber that guides the light from the light source to the laser medium.

As the optical fiber that guides the light from the light source to the laser medium, an SI (Step Index) fiber or a GI (Graded Index) fiber is commonly used. The SI fiber has a core with a fixed refractive index, and a beam profile of the light being guided thereby tends to have a top hat shape. When the beam profile of the light input into the laser medium has the top hat shape, the output of the laser light emitted from the laser oscillator tends to be sufficient.

However, the SI fiber has the core with the fixed refractive index, and a propagation velocity of the light is different between the center of the core and around the core, whereby output of the light being guided is susceptible to a shape change of the fiber and tends to be unstable. When the output of the light input into the laser medium is unstable, the output of the laser light emitted from the laser oscillator also tends to become unstable. Thus, in a case where the SI fiber is used as the optical fiber that guides the light from the light source to the laser medium, while the output of the laser light emitted from the laser oscillator tends to be sufficient, the output tends to be unstable.

On the other hand, the GI fiber has a core with an unfixed refractive index, and a propagation velocity of the light is the same at the center of the core and around the core, whereby output of the light being guided is insusceptible to the shape change of the fiber and tends to be stable. When the output of the light input into the laser medium is stable, the output of the laser light emitted from the laser oscillator also tends to be stable.

However, the GI fiber has the core with the unfixed refractive index, and a beam profile of the light being guided forms a Gaussian waveform. When the beam profile of the light input into the laser medium has the Gaussian waveform, the output of the laser light emitted from the laser oscillator tends to decrease. Thus, in a case where the GI fiber is used as the optical fiber that guides the light from the light source to the laser medium, while the output of the laser light emitted from the laser oscillator tends to be stable, the output thereof tends to decrease.

Thus, in a case where either the SI fiber or the GI fiber is used as the optical fiber that guides the light from the light source to the laser medium, it is difficult to obtain the laser light with stable and sufficient output. Based on this knowledge, the present inventors have made further examinations and have come to achieve the present invention.

That is, a laser apparatus of the present invention includes a light source emitting light; an optical fiber into which the light emitted from the light source is input, the optical fiber guiding and outputting the light; a laser oscillator having a laser medium into which the light output from the optical fiber is input, and emitting laser light, and the optical fiber includes a GI fiber constituting a part on a light input side; and an SI fiber connected to the GI fiber and constituting a part on a light output side.

In the laser apparatus, a part of the optical fiber on a light input side, where the light emitted from the light source is input, is constituted by the GI fiber, whereby in this part, the output of the light being guided is insusceptible to the shape change of the fiber and tends to be stable. Furthermore, a part of the optical fiber on a light output side, where the light being guided is output, is constituted by the SI fiber, whereby the beam profile of the light being output from the optical fiber tends to have the top hat shape. For this reason, the light being input into the laser medium has the output that tends to be stable, and the beam profile thereof tends to have the top hat shape. Thus, by using this laser apparatus, it is possible to obtain the laser light with stable and sufficient output.

### Advantageous Effects of Invention

According to the present invention, it is possible to provide the laser apparatus with which it is possible to obtain the laser light with stable and sufficient output.

### BRIEF DESCRIPTION OF DRAWINGS

FIG. 1 is a configuration diagram of a laser apparatus according to a first embodiment.

FIG. 2 is a configuration diagram of a fixing tool of a SI fiber of the laser apparatus in FIG. 1.

FIG. 3 is a configuration diagram of another exemplary fixing tool of the SI fiber of the laser apparatus in FIG. 1.

FIG. 4 is a configuration diagram of another exemplary fixing tool of the SI fiber of the laser apparatus in FIG. 1.

FIG. 5 is a schematic view of an evaluation method for evaluating an influence of a shape change of an optical fiber.

FIG. 6 is a graph illustrating a result of evaluating the influence of the shape change of the optical fiber.

FIG. 7 is a configuration diagram of a laser apparatus according to a second embodiment.

### DESCRIPTION OF EMBODIMENTS

Hereinafter, an embodiment of a laser apparatus according to the present invention is described in detail with reference to the drawings. In each of the drawings, the same or equivalent parts are denoted by the same reference signs, and a redundant description is omitted therefor.

### First Embodiment

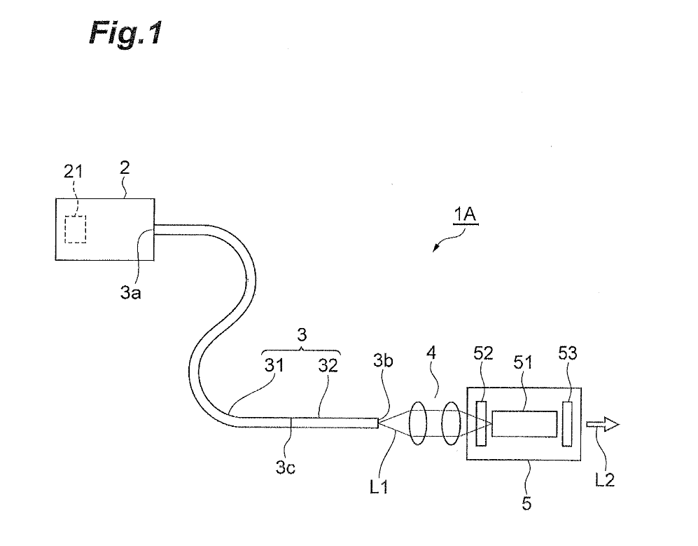

FIG. 1 is a configuration diagram of a laser apparatus according to a first embodiment. As illustrated in FIG. 1, a laser apparatus 1A is provided with a semiconductor laser device 2, an optical fiber 3, an optical system 4, and an optical resonator (laser oscillator) 5. The semiconductor laser device 2 includes a semiconductor laser 21, and an optical system that condenses excitation light L1 emitted from the semiconductor laser 21 on an input end face 3a of the optical fiber 3. To the input end face 3a of the optical fiber 3, the excitation light L1 emitted from the semiconductor laser 21 being a light source is input. The optical fiber 3 guides the excitation light L1, which has been input from the input end face 3a, and outputs the excitation light from an output end face 3b.

The optical fiber 3 includes a GI fiber 31 constituting a part thereof on a light input side (part from the input end face 3a to a predetermined portion 3c of the optical fiber 3), and an SI fiber 32 constituting a part thereof on a light output side (part from the output end face 3b to the predetermined portion 3c). The GI fiber 31 and the SI fiber 32 are connected to each other by fusion connection or the like at the predetermined portion 3c. Preferably, a length of the GI fiber 31 is longer than a length of the SI fiber 32. As the exemplary length of each of the fibers 31 and 32, the length of the GI fiber 31 is 15 cm or more, for example, and the length of the SI fiber 32 is 15 cm or less, for example.

It is preferred that in each of the GI fiber 31 and the SI fiber 32, a core diameter and a numerical aperture be set as below to suppress a propagation loss of the light at a connection interface. That is, when the core diameter of the GI fiber 31 is set to Φ_{GI}, the numerical aperture of the GI fiber 31 is set to NA_{GI}, the core diameter of the SI fiber 32 is set to Φ_{SI}, and the numerical aperture of the SI fiber 32 is set to NA_{SI}, it is preferred that the fibers 31 and 32 satisfy the following Formula (1) when NA_{GI}>NA_{SI} and satisfy the following Formula (2) when NA_{GI}<NA_{SI}.

2Φ_{GI}(NA_{SI}/NA_{GI})≧Φ_{SI}≧(NA_{SI}/NA_{GI}) (1)

2Φ_{GI}≧Φ_{SI}≧Φ_{GI} (2)

The optical system 4 is a condensing lens system that condenses the excitation light L1 output from the output end face 3b of the optical fiber 3 on the optical resonator 5. The optical resonator 5 has a laser medium 51, and a total reflection mirror 52 and a partial reflection mirror 53, which are facing each other interposing the laser medium 51. As the laser medium 51, for example, a solid-state laser medium constituted by a laser medium such as YAG (Y₃Al₅O₁₂) and YVO₄, doped with neodymium (Nd) as a laser active species, may be used. In the laser medium 51, by inputting the excitation light L1, which has been condensed by the optical system 4, the laser active species is excited, and light of a predetermined wavelength is emitted.

The total reflection mirror 52, while transmitting the excitation light L1, totally reflects spontaneous emission light by the laser medium 51. The partial reflection mirror 53 has a lower reflectance than the total reflection mirror 52 for a wavelength of the spontaneous emission light by the laser medium 51. Each of the total reflection mirror 52 and the partial reflection mirror 53 reflects the light emitted by the laser medium 51, causes the light to reciprocate therebetween, and causes stimulated radiation in the laser medium 51. Accordingly, the optical resonator 5 emits laser light L2 from the partial reflection mirror 53. Note that the optical resonator 5 may also be a composite crystal integrally constituted by components from the total reflection mirror 52 to the partial reflection mirror 53.

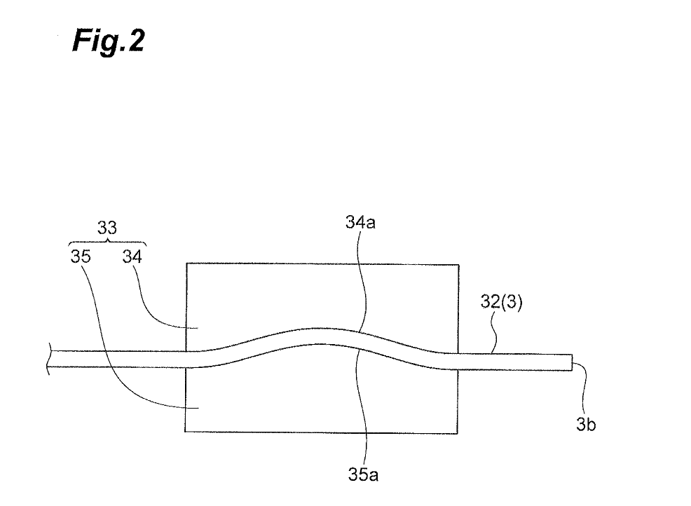

In the laser apparatus 1A in FIG. 1, preferably, the SI fiber 32 is fixed in a curved state. FIG. 2 is a configuration diagram of a fixing tool for the SI fiber of the laser apparatus in FIG. 1. In this configuration example, as illustrated in FIG. 2, the SI fiber 32 is fixed in the curved state by a fixing tool 33. The fixing tool 33 is provided with plate members 34 and 35. The plate members 34 and 35 have opposing surfaces 34a and 35a facing each other, respectively. On the opposing surface 34a, a depressed curved surface is formed. On the opposing surface 35a, a projected curved surface complementary to the curved surface formed on the opposing surface 34a is formed. Accordingly, the plate members 34 and 35 sandwich the SI fiber 32 between the opposing surfaces 34a and 35a, whereby it is possible to fix the SI fiber in the curved state.

The SI fiber 32 has a core with a fixed refractive index, whereby when the SI fiber 32 is linearly wired, the excitation light L1 that is rectilinearly propagating is emitted from a central part of the core, and output becomes high at the central part of the core. In contrast, by using the fixing tool 33, the excitation light L1 that is rectilinearly propagating is repeatedly reflected by a wall of the core, whereby the output becomes uniform in an in-plane direction, and a beam profile of the excitation light L1 guided becomes a top hat shape. As a specific configuration of the fixing tool 33, various configurations other than the above-described configuration may also be used.

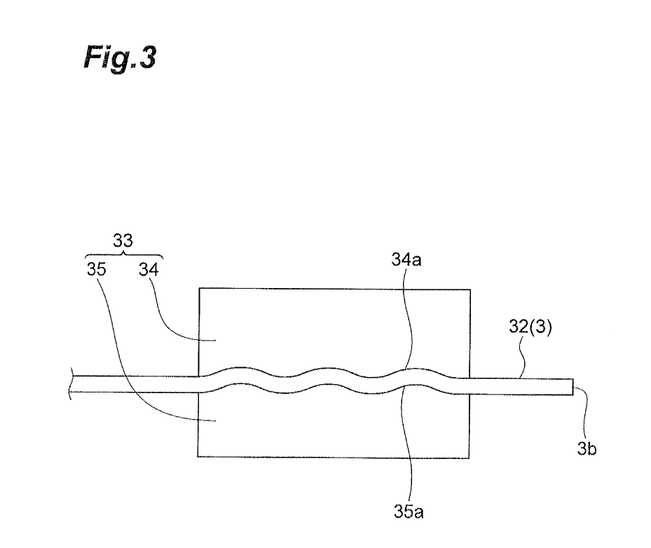

FIG. 3 is a configuration diagram of another exemplary fixing tool for the SI fiber of the laser apparatus. A difference from the configuration in FIG. 2 is that a plurality of curved surfaces are formed on the opposing surfaces 34a and 35a of the plate members 34 and 35 in the fixing tool 33. Accordingly, it is possible to fix the SI fiber 32 along the curved surfaces by curving it for multiple times.

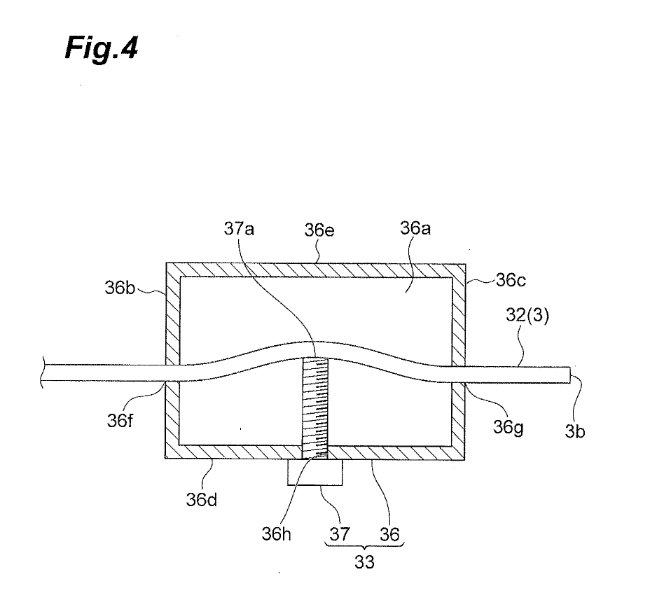

FIG. 4 is a configuration diagram of further another exemplary fixing tool for the SI fiber of the laser apparatus. In this configuration example, as illustrated in FIG. 4, the fixing tool 33 is provided with a box body 36 and a bolt 37. The box body 36 has a rectangular bottom face 36a and rectangular side faces 36b to 36e. Through holes 36f and 36g are provided on the facing side faces 36b and 36c, respectively, on the bottom face 36a side of the box body 36. The SI fiber 32 is wired so as to pass through the box body 36 through the through holes 36f and 36g. The side face 36d, which is perpendicular to the side faces 36b and 36c, of the box body 36 is provided with a screw hole 36h to which the bolt 37 is screwed. The bolt 37 is provided so as to press the SI fiber 32 with a tip portion 37a thereof inside the box body 36. Accordingly, it is possible to fix the SI fiber 32 in a curved manner. An amount of curve may be adjusted by a feeding amount of the bolt 37.

Note that the SI fiber 32 is fixed by the bottom face 36a and the through holes 36f and 36g so as not to move in a radial direction of the fiber at the through holes 36f and 36g, and it contacts the bottom face 36a between the through holes 36f and 36g, and therefore, the SI fiber hardly receives an external stress such as vibration. By providing a plurality of bolts 37 on the side face 36d and the side face 36e facing the side face 36d, it is also possible to configure such that the SI fiber 32 is pressed at multiple positions and curved for multiple times by the bolts.

In the laser apparatus 1A having the above-described configuration, the excitation light L1 emitted from the semiconductor laser 21 is guided by the optical fiber 3, condensed by the optical system 4, and input into the optical resonator 5. The excitation light L1, which has entered the laser medium 51 of the optical resonator 5, excites the laser active species in the laser medium 51 and causes the light of the predetermined wavelength to be emitted. The light that has been emitted by the laser medium 51 is reflected respectively by the reflection mirrors 52 and 53, and by reciprocating between the reflection mirrors 52 and 53, the light causes stimulated emission in the laser medium 51. Accordingly, the laser light L2 is emitted from the optical resonator 5.

When the excitation light L1 is guided by the optical fiber 3, in the GI fiber 31 constituting the part on the input side, the output is insusceptible to a shape change of the fiber and tends to be stable. Furthermore, in the SI fiber 32, the excitation light L1 tends to have the beam profile in the top hat shape. Furthermore, in the above-described configuration example, the SI fiber 32 is fixed by the fixing tool 33 in the curved state, whereby the beam profile of the excitation light L1 tends to be in the top hat shape more securely.

Thus, the excitation light L1 is output from the optical fiber 3 in a state where the output is stable and the beam profile is in the top hat shape. Since such excitation light L1 enters into the laser medium 51, output of the laser light L2 emitted from the optical resonator 5 becomes stable and sufficient. When the excitation light L1 is in the top hat shape, it is advantageous for making the output of the laser light L2 sufficient from a point that a complicated thermal lens is unlikely to occur in the laser medium 51. When the thermal lens occurs, for example, an optical axis of the laser light L2 may be deviated (decrease of directivity) or the laser light L2 may be diverged or converged (decrease of light condensing), whereby a quality of the laser light L2 may be easily decreased.

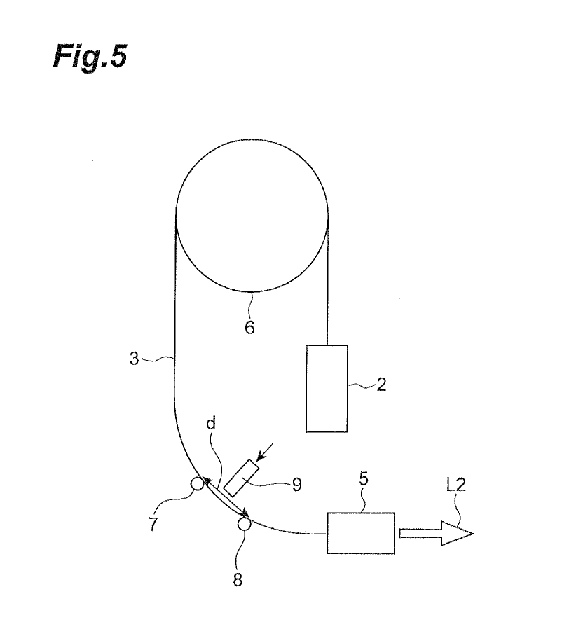

Here, characteristics of the GI fiber 31 and the SI fiber 32 are described. FIG. 5 is a schematic view of an evaluation method for evaluating an influence of a shape change of the optical fiber. As illustrated in FIG. 5, the optical fiber 3 is supported in a curved state by using a reel 6 and support points 7 and 8. As the reel 6, a cylindrical reel having a diameter of 300 mm is used, and the optical fiber 3 is contacted with an outer periphery surface of the reel 6. A distance d between the support point 7 and the support point 8 is set to 68 mm, and the optical fiber 3 is contacted with the support points 7 and 8 at points. Then, to the optical fiber 3, which is supported between the support points 7 and 8 and is bent by its own weight, a force is applied from an opposite side of the support points 7 and 8 in the same direction as the bending by the own weight by using a pressure unit 9. By changing stress by the pressure unit 9 in stages, pulse energy (PE) and a delay are evaluated. Here, the bending by the own weight is 18 mm (curvature radius of 322 mm) using when linearly wired as a reference.

An evaluation is performed for a case using the GI fiber 31 only and a case using the SI fiber 32 only to constitute the optical fiber 3, respectively. Both of the GI fiber 31 and the SI fiber 32 have the same length and have an allowable curvature radius of 150 mm or more. The fixing tool 33 is not used.

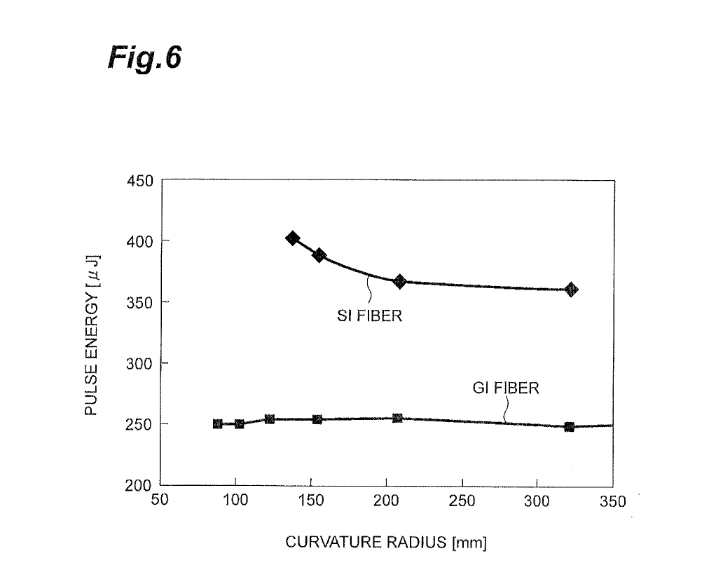

An evaluation result of an influence of the shape change of the optical fiber evaluated in the above method is illustrated in Table 1 and FIG. 6. FIG. 6 is a graph of Table 1. A PE relative value in Table 1 refers to a relative value when the PE at a curvature radius of 154 mm, near the allowable curvature radius, is 100. The curvature radius is roughly estimated from the distance d between the support points 7 and 8 and a position of the pressure unit 9 when pressurized.

TABLE 1

| | | SI fiber | | | GI fiber | | |
|---|---|---|---|---|---|---|---|
| | cur- | | PE | | | PE | |
| | vature | | relative | | | relative | |
| bending | radius | PE | value | delay | PE | value | delay |
| [mm] | [mm] | [μJ] | [%] | [μs] | [μJ] | [%] | [μs] |
| 1.8 | 322 | 361 | 92.8 | 368 | 249 | 98.0 | 416 |
| 2.8 | 208 | 368 | 94.6 | 380 | 255 | 100.4 | 420 |
| 3.8 | 154 | 389 | 100.0 | 428 | 254 | 100.0 | 416 |
| 4.3 | 137 | 401 | 103.1 | 468 | — | — | — |
| 4.8 | 123 | oscillation | oscillation | — | 254 | 100.0 | 420 |
| | | stop | stop | | | | |
| 5.8 | 103 | oscillation | oscillation | — | 250 | 98.4 | 420 |
| | | stop | stop | | | | |
| 6.8 | 88 | oscillation | oscillation | — | 250 | 98.4 | 440 |
| | | stop | stop | | | | |

Table 2 illustrates an evaluation result of evaluating the pulse energy while the optical fiber 3 is in a bending state by its own weight and by optimizing a temperature adjustment of the semiconductor laser 21 and a temperature adjustment of the optical resonator 5.

TABLE 2

| | | | resonator | |
|---|---|---|---|---|
| | PE | delay | temperature | semiconductor laser |
| | [μJ] | [μs] | [%] | drive condition |
| SI fiber | 370 | 380 | 22 | QCW40A (100 Hz, 500 us . . . |
| | | | | Duty 5%) @ 29° C. |
| GI fiber | 249 | 416 | 20 | same as above |

According to Table 1, when the shape change of the fiber is in a range of 137 mm or more of the curvature radius, when the SI fiber 32 is used, the laser light L2 having the high pulse energy is obtained compared to when the GI fiber 31 is used. However, when the shape change of the fiber is in a range of 123 mm or less of the curvature radius, the laser light L2 having the stable pulse energy is obtained when the GI fiber 31 is used, however, oscillation is stopped when the SI fiber 32 is used. In terms of a delay, when the GI fiber 31 is used, it is more stable with little change compared to when the SI fiber 32 is used.

That is, in terms of an output change characteristic against the external stress, it is clear that the GI fiber 31 is superior to the SI fiber 32. Furthermore, according to Table 2, in a state where the temperature adjustment of the semiconductor laser 21 and the temperature adjustment of the optical resonator 5 are optimized, the pulse energy of the GI fiber 31 is about 60% of the SI fiber 32.

As described above, in the laser apparatus 1A according to the present embodiment, a part of the optical fiber 3 on the light input side where the excitation light L1 emitted from the semiconductor laser 21 is input (part from the input end face 3a to the predetermined portion 3c of the optical fiber 3) is constituted by the GI fiber 31. Further, a part of the optical fiber 3 on the light output side where the excitation light L1 being guided is output (part from the output end face 3b to the predetermined portion 3c) is constituted by the SI fiber 32.

Preferably, the length of the GI fiber 31 is longer than the length of the SI fiber 32, and is, for example, 15 cm or more. By using the GI fiber 31, output of the excitation light L1 being guided is insusceptible to the shape change of the fiber and tends to be stable. For this reason, in the above-described configuration example, in the optical fiber 3, as a whole, a length of the part insusceptible to the influence of the shape change is long, whereby the output of the excitation light L1 being guided tends to be stable. On the other hand, in the above-described case, the length of the SI fiber 32 is short, and is, for example, 15 cm or less. By using the SI fiber 32, the output of the excitation light L1 being guided is susceptible to the shape change of the fiber and tends to be unstable, however, since the length of the SI fiber 32 is short, it is possible to suppress the influence to be small.

Furthermore, by using the SI fiber 32, the beam profile of the excitation light L1 output from the optical fiber 3 tends to be in the top hat shape. For this reason, by using the optical fiber 3, the output of the excitation light L1 being input into the laser medium 51 tends to be stable, and the beam profile thereof tends to be in the top hat shape. Thus, the output of the laser light L2 emitted from the optical resonator 5 becomes stable as well.

Furthermore, in the laser apparatus 1A, the SI fiber 32 is fixed in the curved state by the fixing tool 33. Accordingly, even in a case where the length of the part of the SI fiber 32 is short, the beam profile of the excitation light L1 output from the optical fiber 3 tends to be in the top hat shape. Furthermore, since the SI fiber 32 is fixed, a disadvantage of the SI fiber 32 in that the output of the light being guided becomes susceptible to the shape change of the fiber and tends to become unstable hardly occurs. Thus, by using the laser apparatus 1A, it is possible to obtain the laser light L2 having the stable and sufficient output.

In the laser apparatus 1A, the semiconductor laser device 2 and the optical resonator 5 may be installed apart from each other, whereby it is possible to suppress an influence of heat when driving the semiconductor laser 21 from affecting the laser medium 51. Furthermore, the semiconductor laser 21 and the optical resonator 5 may be installed easily even in a space where it is difficult to dispose both in the same place. In addition, since the excitation light L1 is transmitted through the optical fiber 3, it is possible to constitute the laser apparatus 1A by using the optical fiber 3 even in a case where a wavelength of the laser light L2 is not appropriate for transmission through the optical fiber 3.

Since in the laser apparatus 1A, the length of the GI fiber 31 is long, and the output of the excitation light L1 being guided in the part of the GI fiber 31 is insusceptible to the shape change of the fiber and tends to be stable, it is possible to further enhance a degree of freedom of arrangement design of the semiconductor laser device 2 and the optical resonator 5. For example, even in a small space or a complicated space in which most of the part of the optical fiber 3 needs to be bent to be arranged therein, arrangement is easy since only the part of the optical fiber 3 on the light output side where the SI fiber 32 is used needs to be left unbent.

Furthermore, when a core diameter of the GI fiber 31 is set to Φ_{GI}, a numerical aperture of the GI fiber 31 is set to NA_{GI}, a core diameter of the SI fiber 32 is set to Φ_{SI}, and a numerical aperture of the SI fiber 32 is set to NA_{SI}, it is preferred that the laser apparatus 1A satisfy the following Formula (1) when NA_{GI}>NA_{SI} and satisfy the following Formula (2) when NA_{GI}<NA_{SI}. Accordingly, in principle, it is possible to cause all of the excitation light L1 output from the GI fiber 31 to enter the SI fiber 32. For this reason, it is possible to suppress a propagation loss of the excitation light L1 at a connection interface between the GI fiber 31 and the SI fiber 32.

2Φ_{GI}(NA_{SI}/NA_{GI})≧Φ_{SI}≧(NA_{SI}/NA_{GI}) (1)

2Φ_{GI}≧Φ_{SI}≧Φ_{GI} (2)

Furthermore, since the laser apparatus 1A uses the semiconductor laser 21 as a light source for emitting light, it is easy to make an adjustment of a light amount, whereby the suitable excitation light L1 may be obtained.

### Second Embodiment

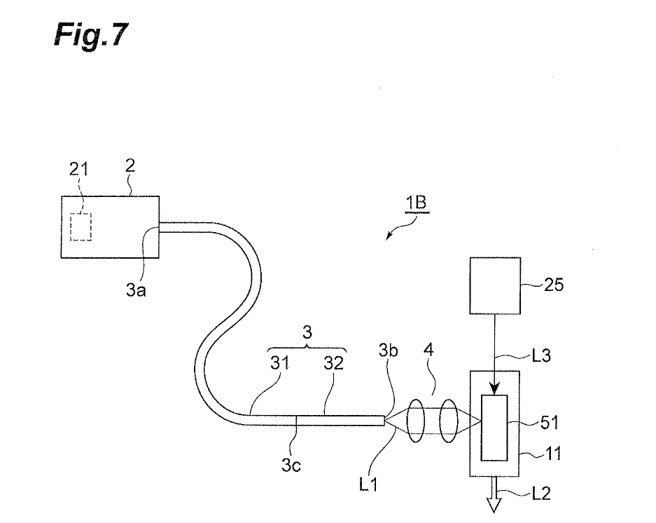

FIG. 7 is a configuration diagram of a laser apparatus according to a second embodiment. As illustrated in FIG. 7, the laser apparatus 1B is provided with an optical amplifier (laser oscillator) 11 in place of the optical resonator 5, which is a main difference from the laser apparatus 1A. The optical amplifier 11 has the laser medium 51. As the laser medium 51, for example, a solid-state laser medium constituted by a laser medium such as YAG (Y₃Al₅O₁₂) and YVO₄, doped with Neodymium (Nd) as a laser active species, may be used. The excitation light L1, which is condensed by the optical system 4, and seed light L3, which is emitted from a different light source (a light source 25 schematically illustrated in FIG. 7), enter the laser medium 51. In the laser medium 51, the laser active species is excited by the excitation light L1, and stimulated emission is caused by the seed light L3, whereby the seed light L3 is amplified. Accordingly, the optical amplifier 11 emits the laser light L2.

In the laser apparatus 1B having the above-described configuration, the excitation light L1 emitted from the semiconductor laser 21 is guided by the optical fiber 3, condensed by the optical system 4, and is input into the optical amplifier 11. The excitation light L1, which has entered the laser medium 51 of the optical amplifier 11, excites the laser active species of the laser medium 51. The seed light L3, which has entered the laser medium 51, causes the stimulated emission in the laser medium 51 and is amplified. Accordingly, the laser light L2 is emitted from the optical amplifier 11.

In the same way as in the laser apparatus 1A, the excitation light L1 is output from the optical fiber 3 in a state where output thereof is stabilized and a beam profile thereof is in a top hat shape. Such excitation light L1 enters the laser medium 51, whereby output of the laser light L2 emitted from the optical amplifier 11 becomes stable and sufficient. When the excitation light L1 is in the top hat shape, it is advantageous for making the output of the laser light L2 sufficient from a point that a complicated thermal lens is unlikely to occur in the laser medium 51.

As described above, in the same way as the laser apparatus 1A, the laser apparatus 1B is provided with the optical fiber 3 in which a part of the optical fiber 3 on the light input side (part from the input end face 3a to the predetermined portion 3c of the optical fiber 3) is constituted by the GI fiber 31 and in which a part of the optical fiber 3 on the light output side where the excitation light L1 being guided is output (part from the output end face 3b to the predetermined portion 3c) is constituted by the SI fiber 32. By using the optical fiber 3, the output of the excitation light L1 input into the laser medium 51 tends to be stable, and the beam profile thereof tends to be in the top hat shape. For this reason, the output of the laser light L2 emitted from the optical amplifier 11 also becomes stable and sufficient. Thus, by using the laser apparatus 1B, it is possible to obtain the laser light L2 having the stable and sufficient output.

The embodiments of the present invention have been described as above, however, the present invention is not to be limited to each of the above-described embodiments. For example, it is also possible to configure such that the light output from the optical fiber 3 is input into the laser medium 51 of the optical amplifier 11 as the seed light L3. In a case where the light output from the optical fiber 3 is used as the seed light L3, output of the seed light L3 tends to be stable, whereby the output of the laser light L2 emitted from the laser apparatus 1B also tends to be stable. Furthermore, since it is easy to obtain the laser light L2 in the top hat shape, in a case where the laser light L2 is input into a mirror, for example, energy of the laser light L2 does not concentrate on a part of the mirror by using the top hat shape, whereby it is unlikely that the mirror breaks. Thus, it is easy to increase the output of the laser light L2, and it can be used in a field where increasing of the output of the laser light is required such as in laser processing.

Furthermore, it is also possible to use the light output from the optical fiber 3 for both of the excitation light L1 and the seed light L3 input into the laser medium 51 of the optical amplifier 11. Accordingly, the output of the laser light L2 emitted from the laser apparatus 1B tends to become more stable and sufficient.

Furthermore, it is also possible to cause the excitation light L1 to enter at multiple positions of the laser medium 51 of the optical amplifier 11. Accordingly, the thermal lens is unlikely to occur in the laser medium 51. In FIG. 7, for a simplification purpose, there has been described a configuration in which the excitation light L1 is input at one position, however, in order to prevent heat distribution from occurring, a common configuration is to cause the excitation light L1 to enter at multiple positions.

Furthermore, in FIG. 7, a side face excitation type has been described in which the excitation light L1 is input into a side face of the laser medium 51 of the optical amplifier 11, however, it may also be an end face excitation type in which the excitation light L1 is input into an end face of the laser medium 51. The excitation light L1 may also be input into both of the end faces of the laser medium 51.

The laser apparatus according to the above-described embodiment is provided with a light source emitting light, an optical fiber inputting the light emitted from the light source and guiding and outputting the light, and a laser oscillator having a laser medium into which the light output from the optical fiber is input and emitting laser light, and is configured such that the optical fiber includes a GI fiber constituting a part on the light input side, and an SI fiber connected to the GI fiber and constituting a part on the light output side.

In the laser apparatus having the above-described configuration, a length of the GI fiber may be configured to be longer than a length of the SI fiber. In this case, a part constituted by the GI fiber is long, and output of the light guided in this part is insusceptible to the shape change of the fiber and tends to be stable, whereby it is possible to enhance a degree of freedom of arrangement design of the light source and the laser oscillator.

In the laser apparatus having the above-described configuration, the SI fiber may also be configured to be fixed in the curved state. In this case, even when a length of the part constituted by the SI fiber is short, the beam profile of the light output from the optical fiber tends to be in the top hat shape.

The laser apparatus having the above-described configuration may also be configured so as to satisfy the following Formula (1) when NA_{GI}>NA_{SI} and satisfy the following Formula (2) when NA_{GI}<NA_{SI}, when a core diameter of the GI fiber is set to Φ_{GI}, a numerical aperture of the GI fiber is set to NA_{GI}, a core diameter of the SI fiber is set to Φ_{SI}, and a numerical aperture of the SI fiber is set to NA_{SI}.

2Φ_{GI}(NA_{SI}/NA_{GI})≧Φ_{SI}≧(NA_{SI}/NA_{GI}) (1)

2Φ_{GI}≧Φ_{SI}≧Φ_{GI} (2)

Accordingly, it is possible to cause the light output from the GI fiber to efficiently enter into the SI fiber. For this reason, it is possible to suppress a propagation loss of the light at a connection interface between the GI fiber and the SI fiber.

In the laser apparatus having the above-described configuration, it is also possible to configure such that the light source is a semiconductor laser. Such light source is suitable as a light source of excitation light and seed light for the laser oscillator.

In the laser apparatus having the above-described configuration, it is also possible to configure such that the laser oscillator is an optical resonator having the laser medium into which the light output from the optical fiber is input as the excitation light. In this case, the excitation light input into the laser medium has output that tends to be stable and the beam profile that tends to be in the top hat shape. By using such excitation light, output of the laser light emitted from the optical resonator tends to be stable and sufficient

In the laser apparatus having the above-described configuration, it is also possible to configure such that the laser oscillator is an optical amplifier having the laser medium into which the light output from the optical fiber is input as the excitation light. In this case, the excitation light input into the laser medium has output that tends to be stable and the beam profile that tends to be in the top hat shape. By using such excitation light, output of the laser light emitted from the optical amplifier tends to be stable and sufficient.

In the laser apparatus having the above-described configuration, it is also possible to configure such that the laser oscillator is an optical amplifier having the laser medium into which the light output from the optical fiber is input as the seed light. In this case, the seed light input into the laser medium has output that tends to be stable and the beam profile that tends to be in the top hat shape. By using such seed light, output of the laser light emitted from the optical amplifier tends to be stable and sufficient.

### INDUSTRIAL APPLICABILITY

The present invention is applicable as a laser apparatus with which it is possible to obtain laser light with stable and sufficient output.

### REFERENCE SIGNS LIST

1A, 1B—laser apparatus, 2—semiconductor laser device, 21—semiconductor laser, 3—optical fiber, 3a—input end face, 3b—output end face, 3c—predetermined portion, 31—GI fiber, 32—SI fiber, 33—fixing tool, 4—optical system, 5—optical resonator, 11—optical amplifier, 51—laser medium, 52—total reflection mirror, 53—partial reflection mirror, L1—excitation light, L2—laser light, L3—seed light.

1. A laser apparatus comprising:
a light source emitting light;
an optical fiber into which the light emitted from the light source is input, the optical fiber guiding and outputting the light;
a laser oscillator having a laser medium into which the light output from the optical fiber is input, and emitting laser light, wherein
the optical fiber includes:
a GI fiber constituting a part on a light input side; and
an SI fiber connected to the GI fiber and constituting a part on a light output side.

2. The laser apparatus according to claim 1, wherein a length of the GI fiber is longer than a length of the SI fiber.

3. The laser apparatus according to claim 1, wherein the SI fiber is fixed in a curved state.

4. The laser apparatus according to claim 1, wherein, when a core diameter of the GI fiber is set to Φ_{GI}, a numerical aperture of the GI fiber is set to NA_{GI}, a core diameter of the SI fiber is set to Φ_{SI}, and a numerical aperture of the SI fiber is set to NA_{SI}, the following Formula (1) is satisfied when NA_{GI}>NA_{SI}, and the following Formula (2) is satisfied when NA_{GI}<NA_{SI},
2Φ_{GI}(NA_{SI}/NA_{GI})≧Φ_{SI}≧(NA_{SI}/NA_{GI}) (1)
2Φ_{GI}≧Φ_{SI}≧Φ_{GI} (2)

5. The laser apparatus according to claim 1, wherein the light source is a semiconductor laser.

6. The laser apparatus according to claim 1, wherein the laser oscillator is an optical resonator having the laser medium into which the light output from the optical fiber is input as excitation light.

7. The laser apparatus according to claim 1, wherein the laser oscillator is an optical amplifier having the laser medium into which the light output from the optical fiber is input as excitation light.

8. The laser apparatus according to claim 1, wherein the laser oscillator is an optical amplifier having the laser medium into which the light output from the optical fiber is input as seed light.
